(19) United States
(12) Patent Application Publication
(10) Pub. No.: US 2011/0157644 A1
(43) Pub. Date: Jun. 30, 2011

(54) IMAGE FORMING APPARATUS

(75) Inventor: Akitoshi Suzuki, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/974,185

(22) Filed: Dec. 21, 2010

Related U.S. Application Data
(60) Provisional application No. 61/290,426, filed on Dec. 28, 2009.

(51) Int. Cl. G06F 3/12

(52) U.S. Cl. 358/1.15

(57) ABSTRACT

Certain embodiments provide an image forming apparatus including: a transmission and reception part to receive printing data and a scheduled number of copies of printing by a USB command from a computer apparatus; a sensor to detect occurrence and removal of an error; a printing part to print the printing data; a storage part to store the number of printed sheets and the scheduled number of copies; a calculation part to calculate a remaining number of copies to be printed based on the number of printed sheets and the scheduled number of copies; and a control part to control the transmission and reception part to transmit the remaining number of copies to the computer apparatus, receive a resumption number of copies having substantially the same value as the remaining number of copies from the computer apparatus after return, and register the resumption number of copies.

### CROSS-REFERENCE TO RELATED APPLICATION

The present application claims priority under 35 U.S.C. 119 to U.S. Provisional Application Ser. No. 61/290,426, entitled IMAGE FORMING APPARATUS, to SUZUKI, filed on Dec. 28, 2009, the entire disclosure of which is incorporated herein by reference.

### FIELD

Embodiments described herein relate generally to an image forming apparatus and a printing method of the image forming apparatus.

### BACKGROUND

There is a case where an image forming apparatus is used in an environment without LAN (local area network). A computer equipment, such as a personal computer, transmits printing data and the scheduled print number of copies to the image forming apparatus through a USB (universal serial bus) cable.

If an error such as a jam occurs, the image forming apparatus stops printing. If a person removes a sheet, the error is eliminated. The personal computer causes the image forming apparatus to resume printing.

However, the image forming apparatus is difficult to return from the state where the error is eliminated to the state where printing is resumed.

It is assumed that an error occurs during a period if the image forming apparatus is printing three copies of printing data of one page.

The personal computer can not determine at which of the first copy, the second copy and the third copy the printing is stopped by the error.

After the image forming apparatus is returned from the stop due to the error, the image forming apparatus resumes printing from the first copy.

The image forming apparatus wastefully consumes sheets. A surplus time is required to complete the printing. If the number of pages of a document is large and the number of copies is large, the image forming apparatus can not complete the printing.

### BRIEF DESCRIPTION OF THE DRAWINGS

FIG. 1 is a view showing a connection relation between an image forming apparatus of an embodiment and a computer apparatus;

FIG. 2 is a view showing the inside structure of the image forming apparatus of the embodiment;

FIG. 3 is a view showing a part of the hardware structure of the image forming apparatus of the embodiment;

FIGS. 4A to 4C are views showing an example of the software structure of the image forming apparatus of the embodiment;

FIG. 5 is a view showing mutual cooperation among plural software modules of the image forming apparatus of the embodiment;

FIG. 6A is a view showing a sequence of a printing method of the image forming apparatus of the embodiment;

FIG. 6B is a view showing a sequence subsequent to FIG. 6A;

FIG. 7 is a view showing an image of printing data for the image forming apparatus of the embodiment;

FIGS. 8A and 8B are views for explaining a procedure until printing of the third copy of the first page is completed;

FIGS. 9A to 9D are views for explaining a procedure until printing of the second copy of the second page is completed;

FIG. 10 is a view showing an example of the display's indication of a computer apparatus;

FIGS. 11A to 11C are views for explaining a procedure until printing of the third copy of the second page is completed; and

FIGS. 12A to 12D are views for explaining a procedure until printing of the third copy of the third page is completed.

### DETAILED DESCRIPTION

Certain embodiments provide an image forming apparatus including: a transmission and reception part configured to transmit and receive a USB command to and from a computer apparatus, and receive printing data of one page and a scheduled number of copies of printing of the printing data page by page from the computer apparatus; a sensor configured to detect occurrence of an error and removal of the error; a printing part configured to print the printing data received by the transmission and reception part onto a sheet and stop a print process by the occurrence of the error during execution of the print process; a storage part configured to store the number of printed sheets and the scheduled number of copies; a calculation part configured to calculate a remaining number of copies to be printed by the printing part based on the number of printed sheets and the scheduled number of copies stored in the storage part; and a control part configured to control the transmission and reception part to transmit the remaining number of copies calculated by the calculation part to the computer apparatus, receive a resumption number of copies having substantially a same value as the remaining number of copies from the computer apparatus after return of the print process from a printing stop by the removal of the error, and register the resumption number of copies in the storage part.

Hereinafter, an image forming apparatus and a printing method of the image forming apparatus will be described in detail with reference to the drawings. Incidentally, in the respective drawings, the same part is denoted by the same reference numeral and its duplicate description is omitted.

The image forming apparatus of the embodiment is an MFP (multi function peripheral). The MFP does not use a LAN (local area network) interface. The MFP is locally connected to a personal computer (computer apparatus) through a USB interface.

A printing method of the image forming apparatus of the embodiment is a method of returning from a printing stop due to an error and resuming the printing if the MFP is made to print by an instruction from the personal computer through the USB interface.

The error indicates a sheet jam or sheet exhaustion. The error includes exhaustion of consumables such as toner.

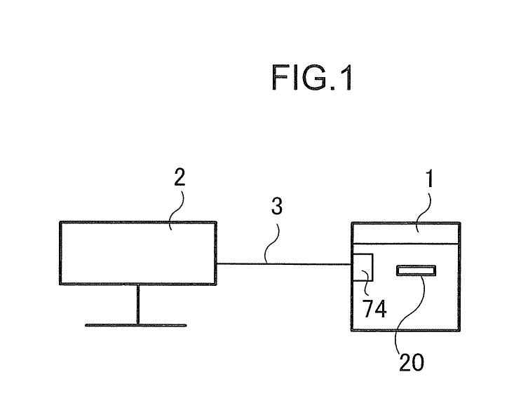

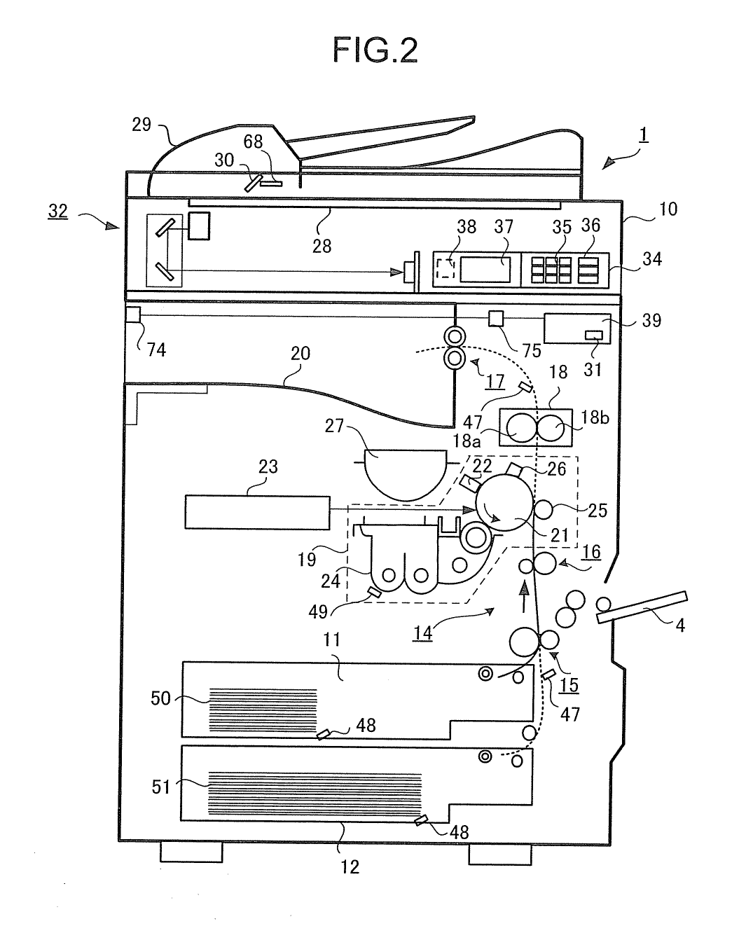

FIG. 1 is a view showing connection relation between an MFP and a personal computer. FIG. 2 is a view showing the inside structure of the MFP. In the drawings, the same reference numeral denotes the same component.

An MFP 1 is connected to a personal computer 2 by a USB cable 3.

The MFP 1 includes cassette parts 11 and 12 at a lower part pf a main body 10. The cassette part 11 contains a sheet 50 of ISO (international standard) A4 size. The cassette part 12 contains a sheet 51 of ISO A3 size.

The MFP 1 includes a conveyance mechanism 14 (printing part). The conveyance mechanism 14 conveys the sheet 50 upward. The conveyance mechanism 14 includes roller pairs 15, 16 and 17 and a fixing unit 18.

The roller pair 15 is a pair of conveyance rollers. The roller pair 15 conveys the sheet 50 to an image forming process part 19 (printing part).

The image forming process part 19 and the conveyance mechanism 14 function as the printing part. The image forming process part 19 and the conveyance mechanism 14 execute a print process, form an image on one side of the sheet 50 and discharge the sheet 50.

The roller pair 16 is a pair of register rollers. The roller pair 17 is a pair of paper discharge rollers. The roller pair 17 guides the printed sheet 50 to a paper discharge tray 20. The fixing unit 18 includes a heat roller 18a and a press roller 18b.

The MFP 1 includes the image forming process part 19 at the center in a height direction of the main body 10. The image forming process part 19 includes a photoconductive drum 21.

The image forming process part 19 includes a charging unit 22, a laser scan unit 23, a developing unit 24, a transfer unit 25 and a cleaner 26 at a side of the outer circumference of the photoconductive drum 21. The image forming process part 19 includes a toner supply device 27 above the developing unit 24.

The photoconductive drum 21 rotates in a counterclockwise direction. The charging unit 22 uniformly charges the photoconductive drum 21.

The laser scan unit 23 irradiates a laser beam to a position on the photoconductive drum 21 to be exposed. The laser scan unit 23 forms an electrostatic latent image on the photoconductive drum 21. The developing unit 24 develops the electrostatic latent image on the photoconductive drum 21.

The transfer unit 25 includes a transfer roller. The transfer unit 25 is charged. The transfer unit 25 transfers the toner image on the photoconductive drum 21 to the sheet 50. The cleaner 26 removes toner remaining on the photoconductive drum 21.

The MFP 1 includes a glass plate 28 at an upper part of the main body 10. The MFP 1 includes an automatic document feeder 29 on the glass plate 28.

The MFP 1 includes an image sensor unit 30 in the automatic document feeder 29. The image sensor unit 30 is a CIS (contact image sensor) unit.

The image sensor unit 30 is moved by a motor in a sub-scanning direction. An ADF (automatic document feeder) control board 68 drives the motor. The image sensor unit 30 reads an upper surface of a document and outputs a read signal to an image processing part 31.

The image processing part 31 creates image data having a pixel pattern of a set of bits.

The image processing part 31 converts the signal outputted from the image sensor unit 30 and a scanner unit 32 into image data. The image processing part 31 stores the image data in a memory. The image processing part 31 is an LSI (large scale integration).

The MFP 1 includes the scanner unit 32 below the glass plate 28. The scanner unit 32 reads the lower surface of a document on the glass plate 28. The scanner unit 32 reads the lower surface of the document, and outputs a read signal to the image processing part 31.

The laser scan unit 23 modulates laser light based on the image data. The photoconductive drum 21 forms an electrostatic latent image corresponding to an image to be copied on the photoconductive drum 21. The developing unit 24 charges toner and attaches the toner to the electrostatic latent image.

The conveyance mechanism 14 pulls up the sheet 50 from the cassette part 11 or 12. The conveyance mechanism 14 aligns the leading end of the sheet 50 by the roller pair 16.

The image forming process part 19 applies a bias to the sheet 50 by the transfer unit 25. The image forming process part 19 transfers the toner to the sheet 50 by electrostatic force.

The conveyance mechanism 14 conveys the sheet 50 to the fixing unit 18. The fixing unit 18 applies heat and pressure to the sheet 50. The fixing unit 18 fixes the toner image on the sheet 50. The conveyance mechanism 14 discharges the sheet 50 subjected to the image formation to the paper discharge tray 20.

The respective nips of the roller pairs 15, 16 and 17, the transfer unit 25 and the fixing unit 18 define a conveyance path of the sheet 50.

The MFP 1 includes a controller 39 for the whole control. The MFP 1 includes jam sensors 47 (sensor) at plural middle places of the conveyance path. The jam sensor 47 detects the occurrence of a print error and the removal of the print error.

As an example, the jam sensor 47 includes a light emitting element, a light receiving element and a timer. The light emitting element irradiates a light beam. The light receiving element receives the reflected light from the sheet 50. The timer has a threshold of time.

The jam sensor 47 detects the occurrence of a jam if time in which the light receiving element continues to be ON is up. The jam sensor 47 detects the removal of the jam if time in which the light receiving element continues to be OFF is up.

The jam sensor 47 detects the occurrence of the jam if the light receiving element does not detect the sheet 50 to be conveyed even after a predetermined time passes.

Each of the jam sensors 47 notifies the controller 39 that the jam occurs. The controller 39 receives a signal from the jam sensor 47. The controller 39 monitors the sheet size information of the sheet 50 and the conveyance speed of the sheet 50.

If the jam sensor 47 notifies the occurrence of the jam of the sheet 50, the controller 39 causes the image forming process part 19 to stop a print process. If the jam sensor 47 where a jam is occurring notifies the controller 39 of the removal of the jam, the controller causes the image forming process part 19 to resume the print process.

The MFP 1 includes a manual paper feed tray 4 below the image forming process part 19. The manual paper feed tray 4 is opened and closed at the side of the main body 10.

The MFP 1 includes an operation panel 34 at the upper part of the main body 10. The operation panel 34 includes plural keys 35, an LED (light emitting diode) 36, a display 37 and a panel board 38.

The display 37 is an LCD (liquid crystal display). The panel board 38 is a control board including a drive circuit.

The control by the controller 39 includes main control, panel control, memory control, codec control, scanner control, printer control, and personal computer interface (PCIF) control.

The main control is system control and job control. The codec control is control of data compression and expansion.

The MFP 1 and the personal computer 2 transmit and receive a command. The command is a command signal. The command is a data signal of an AT command belonging to an AT command set (Hayes command set).

The MFP 1 and the personal computer 2 insert a parameter into the command. The parameter is a data signal added to the AT command.

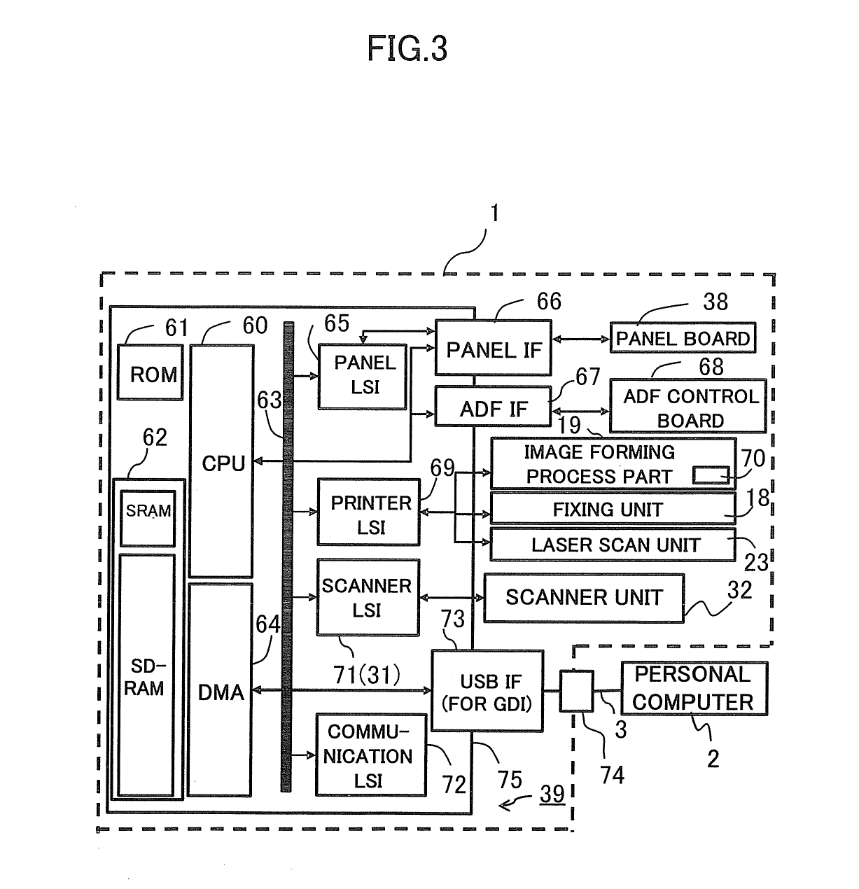

A hardware structure and a software structure concerning the controller 39 will be described with reference to FIGS. 3 to 5.

FIG. 3 is a view showing a part of the hardware structure in which the control of the MFP 1 is main. The same reference numerals as the previously mentioned ones denote the same components.

The controller 39 includes a CPU (central processing unit) 60, a ROM (read only memory) 61, a RAM (random access memory) 62 and a bus 63 on a control board 75.

The CPU 60 executes a program. The program is a device driver, an inter-device control software, a middleware, and an application (application software).

The ROM 61 is an FROM to store an OS (operating system) and various programs.

The RAM 62 creates a print queue of printing data. The printing data is a document of one page.

The RAM 62 functions as a storage part. The RAM 62 stores the number of printed sheets and the scheduled print number of copies.

The RAM 62 includes an SDRAM (synchronous dynamic random access memory) having a volatile work area and an SRAM (static random access memory) having a nonvolatile storage area.

The controller 39 includes the bus 63 and a DMA (direct memory access) controller 64. The bus 63 is a system bus. The DMA controller 64 DMA transfers data on the bus 63.

The controller 39 includes a panel LSI 65 and a panel interface 66. The panel LSI 65 is for display driving. The panel interface 66 interfaces the panel board 38 with the panel LSI 65.

The controller 39 controls the ADF control board 68 through an ADF interface 67. The ADF control board 68 controls the movement amount of the image sensor unit 30.

The controller 39 includes a printer LSI 69. The printer LSI 69 controls the image forming process part 19, the fixing unit 18 and the laser scan unit 23.

Besides, the image forming process part 19 includes a counter 70. The counter 70 counts the number of the printed and outputted sheets 50. The counter 70 increments the counter value each time the image forming process part 19 prints and outputs the sheet 50 after completion of printing.

The counter 70 is, for example, a hardware register. The CPU 60 loads a counter value to the RAM 62. The CPU 60 inserts the counter value into a command.

The controller 39 includes a scanner LSI 71. The scanner LSI 71 functions as the image processing part 31.

The controller 39 includes a communication control LSI 72. The communication control LSI 72 analyzes a received AT command, and determines an AT command to be transmitted.

The controller 39 includes a USB interface 73 (transmission and reception part). The USB interface 73 transmits and receives a command. The controller 39 monitors a USB plug 74 by the USB interface 73.

As an example of the monitoring, the controller 39 detects that the personal computer 2 is connected to the USB plug 74 through the USB cable 3. The controller 39 transmits an enquiry to the personal computer 2, and receives device identification information from the personal computer 2.

The controller 39 loads a device driver to the OS. The OS assigns an intrinsic address on the bus 63 to the personal computer 2. The controller 39 schedules data transfer between the MFP 1 and the personal computer 2.

The user pulls out the USB cable 3 or the personal computer 2 from the USB plug 74. The controller 39 detects that the USB cable 3 is disconnected. The OS releases the address assignment to the personal computer 2. The OS unloads the device driver.

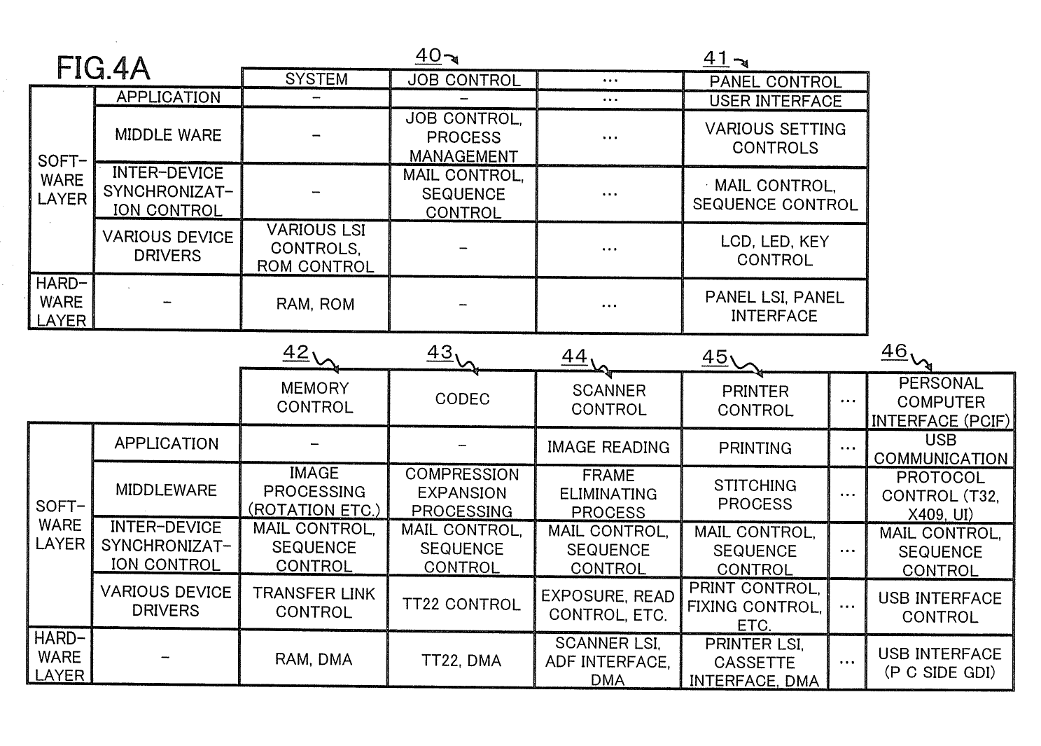

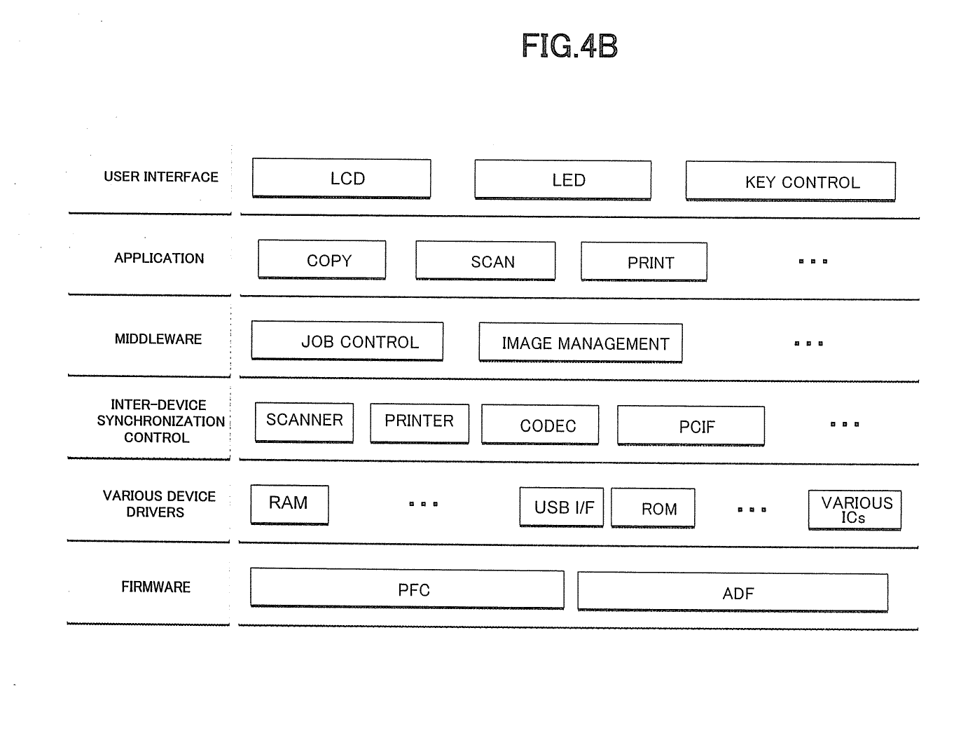

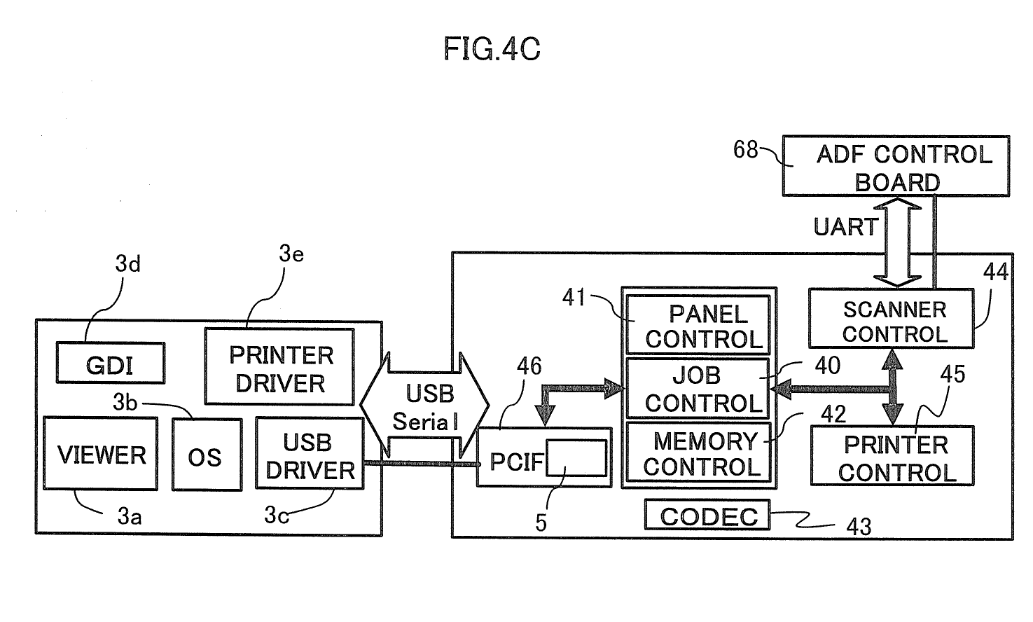

FIGS. 4A to 4C show an example of the software structure of the MFP 1.

FIG. 4A is a diagram showing a control portion of plural software modules. FIG. 4B is a view showing an example of a layer structure of the software module. FIG. 4C is a view showing an example of relation among the software modules. In FIGS. 4A to 4C, the same reference numerals as the previously mentioned ones denote the same components.

A layer indicates a layer classified for executing a function of one control portion. In the MFP 1, the software module into units for respective layers, and is operated.

As shown in FIG. 4A, the MFP 1 executes, as control items, system, job control (job management), panel control, memory control, codec, scanner control, printer control, and personal computer interface (PCIF) control.

The system is a software module for controlling the ROM 61, the RAM 62 and various LSIs.

A job control module 40 is a software module for job management, process control, mail control and sequence control.

The job is a unit of process viewed from the user. The process is a program execution unit for the job.

The mail is message communication between plural processes. The sequence is contents of a process previously defined by plural states and plural events.

A panel control module 41 is a software module for controlling the operation panel 34.

A memory control module 42 is a software module for reading/writing data stored in the RAM 62.

A codec module 43 is a software module for compression and expansion.

A scanner control module 44 is a software module for controlling the scanner unit 32.

A printer control module 45 is a software module for controlling the image forming process part 19 and the conveyance mechanism 14.

A personal computer interface module 46 (control part) is a software module for communication with the personal computer 2.

In FIG. 4B, firmware is for controlling the cassette parts 11 and 12 and the automatic document feeder 29.

Various device drivers are a processing system for directly controlling registers in order to utilize the hardware.

The CPU 60 installs device drivers in the OS. The OS operates peripheral equipments through the device drivers.

The MFP 1 stores the respective device drivers of the RAM 62, the ROM 61, the USB interface 73, and various ICs (integrated circuit). The IC is a general-purpose LSI or ASIC (application specific integrated circuit).

The inter-device synchronization control is a processing system which functions if synchronization with a peripheral module is performed in a process in which the CPU 60 processes a device driver.

The middleware is a function and a processing system to perform an adjustment viewed from the whole system and an intermediate process for another module.

The application is a function and a processing system capable of directly giving a benefit in visible form to the user.

The personal computer interface module 46 will be described in detail.

The personal computer interface module 46 is a control part.

The personal computer interface module 46 causes the USB interface 73 to transmit the remaining number of copies to the personal computer 2. After return of the print process from a printing stop by removal of an error is made, the personal computer interface module 46 causes the USB interface 73 to receive the resumption number of copies from the personal computer 2.

The personal computer interface module 46 registers the resumption number of copies in the RAM 62 through, for example, the memory control module 42.

In the personal computer interface module 46, a software module belonging to an application layer has a function of USB communication.

A software module belonging to a middleware layer encodes data and decodes data.

The personal computer interface module 46 uses a coding/decoding scheme suitable for data in which the bit length is long and the bit length is variable.

A software module belonging to an inter-device synchronization control layer has a function of mail control and sequence control.

A software module belonging to a device driver layer has a function of USB interface control.

After the printing stop due to an error, the personal computer interface module 46 inserts the remaining number of copies to be printed, as a parameter, into a command and sends the command to the personal computer 2.

The personal computer 2 again inserts the resumption number of copies after return from the error stop into the parameter, and sends back the command to the personal computer interface module 46. The resumption number of copies has the same value as the value of the remaining number of copies.

The MFP 1 and the personal computer 2 originally have a function to transmit and receive a command. In this embodiment, the MFP 1 and the personal computer 2 have a function to notify the remaining number of copies and the resumption number of copies.

In this embodiment, in the inside of the MFP 1, software modules surrounded by circular frames in FIG. 4A have a function to insert a parameter and to read a parameter.

If extracting the resumption number of copies, the personal computer interface module 46 notifies the codec module 43, the scanner control module 44, and the printer control module 45 of the resumption number of copies after return from a print interruption state.

The memory control module 42, the codec module 43, the scanner control module 44, the printer control module 45 and the personal computer interface module 46 share parameters among the modules, and control the print sequence.

In the printing method of the embodiment, a print process starts, the print process is stopped by an error in the MFP 1 which is executing the print process, return is made by the removal of the error, and the MFP 1 notifies the personal computer 2 of the remaining number of copies after the resumption from the interruption.

In the printing method, the MFP 1 detects that the error is removed, and the personal computer 2 again sets the notified remaining number of copies, as the print number of copies after the resumption, in the MFP 1.

In the printing method, the remaining number of copies is calculated by a following expression (i).

The remaining number of copies=(the print number of copies notified from the personal computer 2 to MFP 1 at the time of print start)−(the number of printed copies in a period from the print start to the printing stop by an error) (i)

The above is the description of the structure of the MFP 1.

Hereinafter, a structural example of the personal computer 2 will be described.

As shown in FIG. 4C, the software module of the personal computer 2 includes a viewer 3a, an OS 3b, a USB driver part 3c, a graphic device interface 3d, and a printer driver 3e.

The viewer 3a is an application on the OS 3b. The viewer 3a displays a menu screen for dialog. The viewer 3a accepts setting by the user.

The viewer 3a accepts selection information and numerical values about sheet size (A3 or A4), the print number of copies (1 to 999 at the most), and paper type (standard paper or thick paper).

The viewer 3a sends the information set by the user to the OS 3b. The USB driver part 3c creates a command including the setting information and sends the command to the MFP 1.

The USB driver 3c functions also as an end point. The end point is an end of a logical communication channel between the MFP 1 and the personal computer 2.

The graphic device interface 3d communicates data between, for example, a document creating application and the MFP 1. The graphic device interface 3d converts a document into, for example, a bitmap.

The printer driver 3e creates printing data. The printer driver 3e receives image data from the graphic device interface 3d. The printer driver 3e converts the image data into the printing data which can be interpreted by the MFP 1.

The communication between the MFP 1 and the personal computer 2 will be described.

The USB plug 74 of the MFP 1 includes four wires. The two wires are lines for a power source and a ground. The other two wires are lines for signals (D+, D−).

The USB interface 73 receives the D+ signal and the D− signal from the personal computer 2. The USB interface 73 incorporates respective functions of USB device control, buffering, timer and the like.

The USB interface 73 causes the buffer to function as an end point opposite to an end point on the personal computer 2 side. The USB interface 73 causes the USB device controller to operate so that the buffer is activated.

The personal computer interface module 46 causes the application “USB communication” of FIG. 4A to run.

The USB interface 73 provides the application “USB communication” with the logical communication channel between the MFP 1 and the personal computer 2.

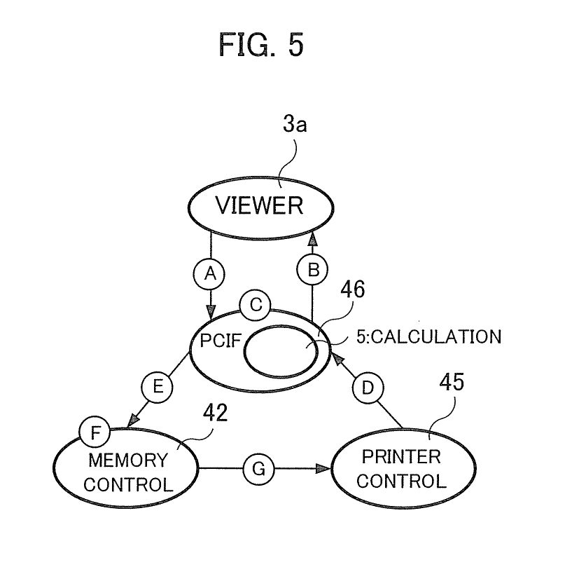

FIG. 5 is a view showing mutual cooperation among the viewer 3a, the personal computer interface module 46, the memory control module 42 and the printer control module 45.

As indicated by (A), the personal computer interface module 46 receives a command and a parameter attached to the command from the viewer 3a.

The parameter includes a paper feed source, the scheduled print number of copies, paper type and the resumption number of copies after return. The paper feed source identifies the sheet size. The parameter indicates “A4”, “three copies”, “standard paper”, “0” and the like.

If receiving a “print start” command, the viewer 3a extracts “the resumption number of copies” from the parameter.

As indicated by (B), the personal computer interface module 46 transmits a command, and notifies that the print process is stopped by an error.

If the print is stopped, the personal computer interface module 46 creates a parameter including “page number” and “the resumption number of copies”.

For example, the personal computer interface module 46 creates a parameter including “second page” and “two copies”.

The personal computer interface module 46 denoted by (C) receives, creates and transmits an AT command.

The personal computer interface module 46 creates mail information, and delivers the mail information to a software module other than the personal computer interface module 46.

The personal computer interface module 46 embeds “the resumption number of copies” in the mail information, and sets the resumption number of copies in the respective inside software modules.

The personal computer interface module 46 includes a calculation part 5. The calculation part 5 calculates the remaining number of copies to be printed by the image forming process part 19 based on the number of printed sheets and the scheduled print number of copies stored in the RAM 62.

As indicated by (D), the printer control module 45 notifies the personal computer interface module 46 of the counter value of the counter 70.

The printer control module 45 notifies the personal computer interface module 46 of “paper discharge completion” each time the print output is completed.

The printer control module 45 initializes the counter value of the counter 70 by notification from the personal computer interface module 46.

As indicated by (E), by notifying the mail information among the software modules, the personal computer interface module 46 sets the resumption number of copies in the memory control module 42.

As indicated by (F), the memory control module 42 attaches page information to the received printing data. The page information indicates the paper feed source of the page and the paper discharge destination.

The memory control module 42 sets the number of times of printing of the printing data in one of the whole print number of copies and the resumption number of copies.

As indicated by (G), the memory control module 42 notifies the printer control module 45 of the page information.

The operation of the MFP 1 having the foregoing structure will be described.

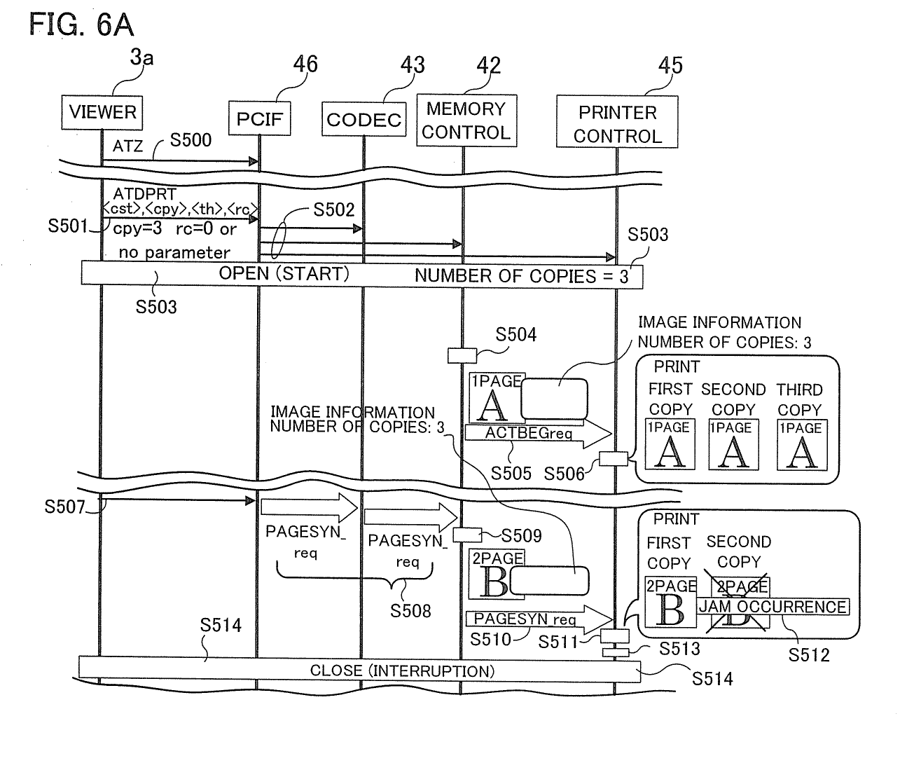

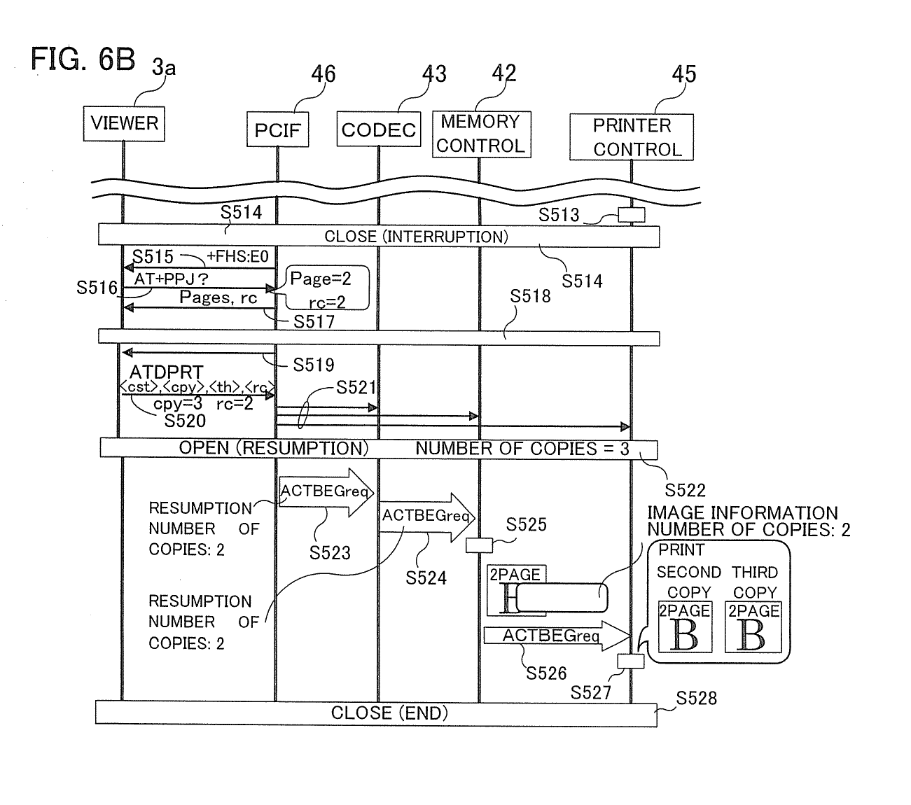

FIG. 6A is a view showing a sequence of the printing method. In the drawing, the same reference numerals as the previously mentioned ones denote the same components.

That the number of pages of a document is assumed to be three and the print number of copies of each page is three. The viewer 3a sends the printing data of one page to the personal computer interface module 46.

At Act S500, the viewer 3a sends a job start command to the personal computer interface module 46.

At ACT S501, the viewer 3a sends a print start command of the first page to the personal computer interface module 46.

The viewer 3a sends parameters of a paper feed source cst, the print number of copies cpy, a paper type th, and the resumption number of copies rc by the command.

The viewer 3a creates parameters of the print number of copies cpy=3 and the resumption number of copies rc=0. Alternatively, the viewer 3a sends the parameter of the print number of copies cpy=3 without using the parameter field of the resumption number of copies rc.

At Act S502, the personal computer interface module 46 receives the command.

The personal computer interface module 46 sets the received parameters by mail in the codec module 43, the memory control module 42, and the printer control module 45.

At Act S502, the memory control module 42 registers a correspondence relation between the page number and the scheduled print number of copies in the RAM 62. The correspondence relation of the first page and three is registered.

At Act S503, the personal computer interface module 46 opens a communication channel. The communication starts. The viewer 3a transfer the printing data to the personal computer interface module 46.

The codec module 43, the memory control module 42, and the printer control module 45 share the mail information of the print number of copies=3.

At Act S504, the memory control module 42 determines which of the following two is used as the value of the print number of copies.

The memory control module 42 sets one of the whole number of copies cpy and the resumption number of copies rc to the print number of copies. The memory control module 42 selects the whole number of copies cpy. The number of times of printing=3 is set.

At Act S505, the memory control module 42 sends the image information, “the number of copies=3” and the print request to the printer control module 45. The memory control module 42 attaches the information of “the resumption number of copies is zero” to “the number of copies=3”.

At S506, the printer control module 45 actuates the image forming process part 19. The image forming process part 19 repeats the print output of the first page three times.

At act S506, the printer control module 45 counts up the counter 70 each time the one sheet 50 is discharged.

By referring to the counter value, the personal computer interface module 46 can know the number of printed sheets 50.

By the above, three copies of the first page are printed.

Subsequently, at Act S507, the personal computer interface module 46 sends a print start command of the second page. The viewer 3a sends printing data of the second page to the personal computer interface module 46.

At Act S508, the personal computer interface module 46 sends the printing data to the codec module 43. The codec module 43 sends the printing data to the memory control module 42.

At Act S509, the memory control module 42 registers the correspondence relation of the second page and three in the RAM 62.

At Act S510, the memory control module 42 sends image information of the second page, “the number of copies=3” and the print request to the printer control module 45.

At Act S511, the printer control module 45 causes the image forming process part 19 to start to print the second page. The image forming process part 19 prints and outputs the first copy of the second page. The printer control module 45 increments the counter 70.

At Act S512, an error occurs if the image forming processing part 19 is printing the second copy of the second page.

At Act S513, the jam sensor 47 detects that the sheet 50 is clogged in the conveyance mechanism 14, the fixing unit 18 or the image forming process part 19. The jam sensor 47 generates an interruption. The job control module 40 detects the interruption.

Alternatively, a sheet sensor 48 (sensor) detects that the sheet 50 does not exist in the cassette part 11. Alternatively, a toner empty sensor 49 (sensor) in the developing unit 24 detects toner exhaustion. The job control module 40 detects also the interruption created by the sheet sensor 48 and the toner empty sensor 49.

At Act S514, the personal computer interface module 46 closes the communication channel.

FIG. 6B is a view showing a sequence subsequent to FIG. 6A. In the drawing, the same reference numerals as the previously mentioned ones denote the same components.

At Act S515, the personal computer interface module 46 notifies the viewer 3a of abnormal termination in the middle of the job. The communication termination (line off) is notified to the viewer 3a.

At Act S516, the viewer sends an enquiry to the personal computer interface module 46.

At Act S517, the personal computer interface module 46 sends the page number Pages at which the printing is stopped and the resumption number of copies rc to the viewer 3a. The page number=2 and the resumption number of copies=2 are notified to the viewer 3a.

If printing is stopped by the error, the resumption number of copies is notified from the MFP 1 to the personal computer 2. The user positioned near the personal computer 2 removes the sheet 50. The error is eliminated.

At Act S518, the jam sensor 47 detects that the print error is removed. The jam sensor 47 sends a signal indicating the removal to the controller 39. The calculation part 5 of the controller 39 calculates the remaining number of copies.

An example in a case where the sheet sensor 48 or the toner empty sensor 49 detects the removal of a print error is the same as the example of the jam sensor 47.

At Act S519, the personal computer interface module 46 notifies the viewer 3a of the error removal.

At Act 520, the viewer 3a sends a print start command of the second page to the personal computer interface module 46.

At Act S521, the viewer 3a sends parameters of the print number of copies cpy=3 and the resumption number of copies rc=2 to the personal computer interface module 46.

At Act S521, the personal computer interface module 46 sets the received parameters in the codec module 43, the memory control module 42 and the printer control module 45.

At Act S522, the communication resumes. The viewer 3a transfers the printing data to the personal computer interface module 46.

At Act S523, the personal computer interface module 46 sends the resumption number of copies rc (rc=2) to the codec module 43.

At Act S524, the codec module 43 sends the resumption number of copies rc (rc=2) to the memory control module 42.

At Act S525, the memory control module 42 registers the correspondence relation (second page, two) between the page number and the resumption number of copies into the RAM 62. That is, the memory control module 42 adds the new correspondence relation (second page, two) to the original correspondence relation (second page, three).

The memory control module 42 determines that with respect to the second page, and the whole number of copies cpy (cpy=3) and the resumption number of copies rc (rc=2), the resumption number of copies rc (rc=2) is used.

At Ac S526, the memory control module 42 sends the image information, “the number of copies=2” and the print request to the printer control module 45. The memory control module 42 attaches the information that “the resumption number of copies is set” to “the number of copies=2”.

At Act S527, the printer control module 45 actuates the image forming process part 19. The image forming process part 19 repeats the print output of the second page twice. After the error is improved, the suspended printing of the remaining page is completed.

At Act S528, the personal computer interface module 46 closes the communication channel.

As described above, if the reception parameter includes the purport that the resumption number of copies rc exists, the personal computer interface module 46 executes midway resumption.

Hereinafter, a specific example of the sequence of the printing method of the image forming apparatus of the embodiment will be described.

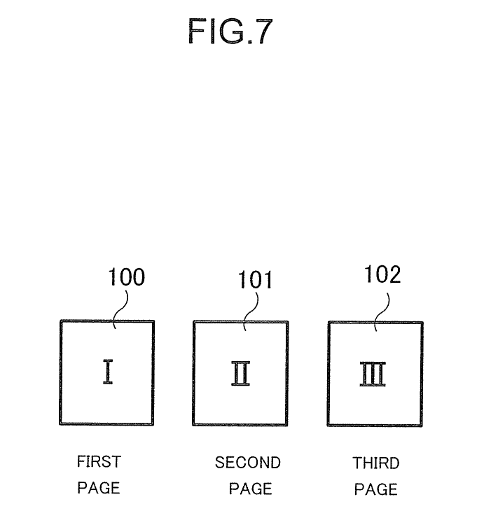

FIG. 7 is a view showing an image of printing data. Each of a first page 100, a second page 101 and a third page 102 represents image data of one page to be printed.

In an example, the following (1) to (4) are simulated.

(1) The MFP 1 normally prints three copies of the first page;

(2) printing is stopped by an error at the second copy of the second page;

(3) after resumption, printing is stopped by an error at the third copy of the second page; and

(4) after resumption, printing is stopped by an error at the third copy of the third page.

The personal computer 2 notifies the MFP 1 of the information of the print number of copies=3, non-sorting, and one-sided printing.

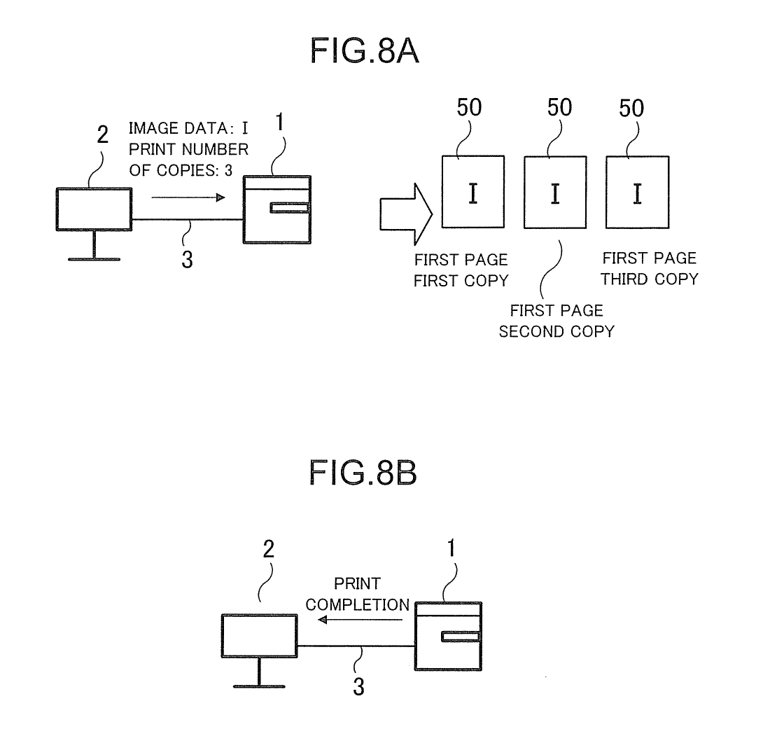

FIGS. 8A and 8B are views for explaining a procedure until printing of the third copy of the first page is completed.

As shown in FIG. 8A, the user performs printing from the personal computer 2. The personal computer 2 sends the image data I of the first page and the print number of copies=3 to the MFP 1.

The MFP 1 prints the image data I on one side of each of three sheets 50. The MFP 1 completes printing of the three sheets 50.

As shown in FIG. 8B, after the printing is completed, the MFP 1 notifies the personal computer 2 of the print completion command.

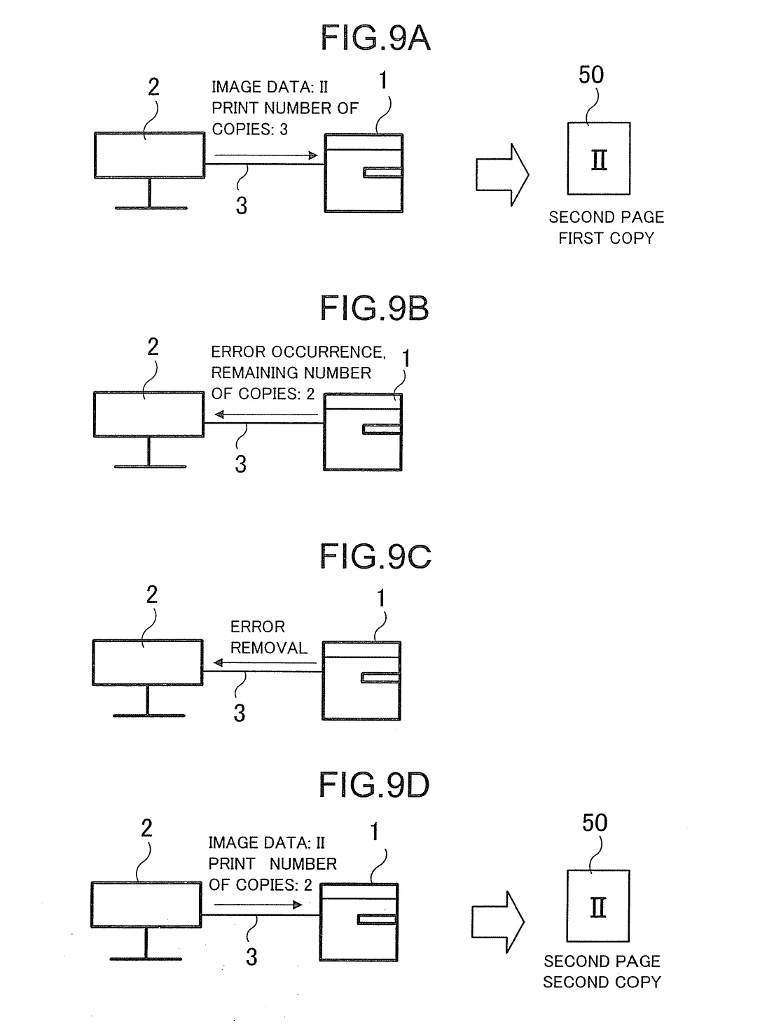

FIGS. 9A, 9B, 9C and 9D are views for explaining a procedure until the printing of the second copy of the second page is completed.

As shown in FIG. 9A, the personal computer 2 sends the image data II of the second page and the print number of copies=3 to the MFP 1.

The MFP 1 starts one-sided printing of the image data II. The MFP 1 outputs the print of the first sheet 50.

An error occurs during printing of the image data II.

The MFP 1 calculates the remaining number of copies by “the print number of copies−the number of printed copies”. In the example of the drawing, the MFP 1 obtains 3−1=2.

As shown in FIG. 9B, after completion of the printing, the MFP 1 notifies the personal computer 2 of the occurrence of the error and the remaining number of copies=2.

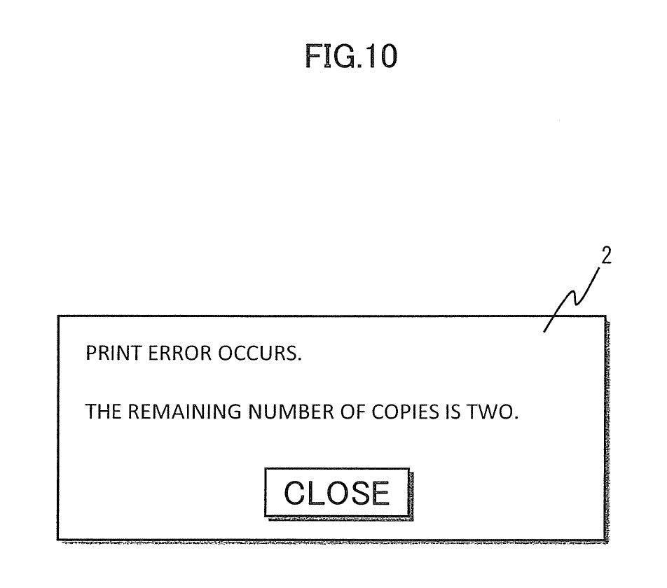

FIG. 10 is a view showing an example of the display's indication of the personal computer 2. The personal computer 2 displays the occurrence of the print error and the remaining number of copies.

The user standing near the MFP 1 removes the clogged sheet 50. The MFP 1 detects that the error is removed.

As shown in FIG. 9C, after the error is eliminated, the MFP 1 notifies the personal computer 2 of the removal of the error.

The personal computer 2 starts to resume automatically.

As shown in FIG. 9D, after resumption, the personal computer 2 sends the image data II and the remaining print number of copies=2 to the MFP 1.

The MFP 1 resumes printing from the image data II. The MFP 1 prints and outputs the sheet 50.

After the resumption, the printing is stopped by an error at the third copy of the second page. The MFP 1 calculates “the print number of copies−the number of printed copies”, and obtains 2−1=1.

The MFP 1 uses the completion number of copies after the resumption of printing of the second page instead of the whole completion number of copies. The MFP 1 uses, as the print number of copies, the number of printed copies notified from the personal computer 2 after the resumption of printing of the second page.

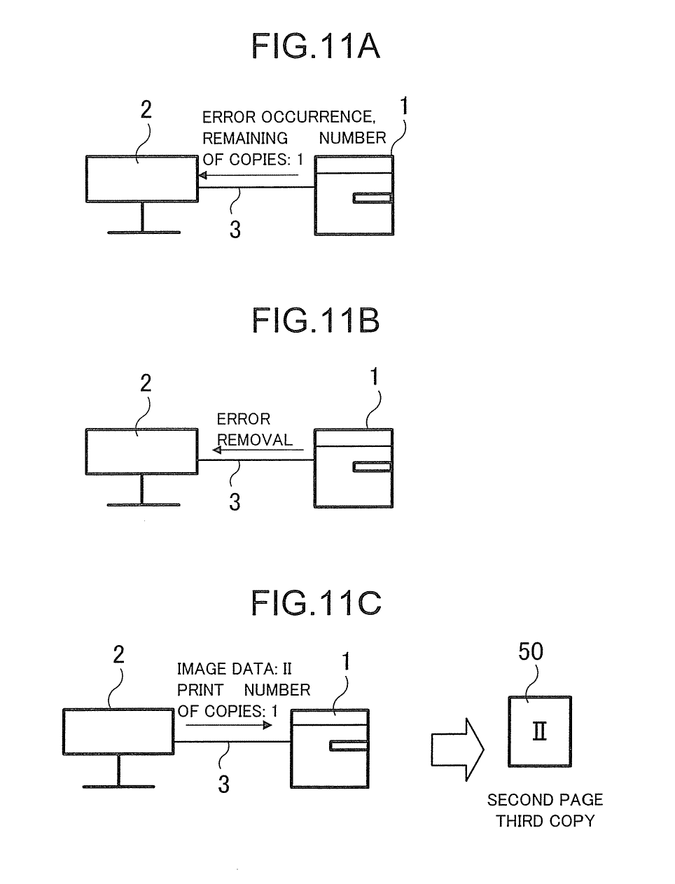

FIGS. 11A, 11B and 11C are views for explaining a procedure until printing of the third copy of the second page is completed.

As shown in FIG. 11A, the MFP 1 notifies the personal computer 2 of the occurrence of the error and the remaining number of copies=1. Thereafter, the user removes the clogged sheet 50, and the error is eliminated.

After that, the personal computer 2 starts to resume automatically.

As shown in FIG. 11C, after the resumption, the personal computer 2 sends the image data II and the remaining number of copies=1 to the MFP 1.

The MFP 1 resumes printing from the image data II. The MFP 1 prints and outputs the third copy of the second page to the sheet 50.

From the above, the MFP 1 automatically resumes printing from the third copy of the second page. The sheet 50 of the third copy of the second page is printed and outputted.

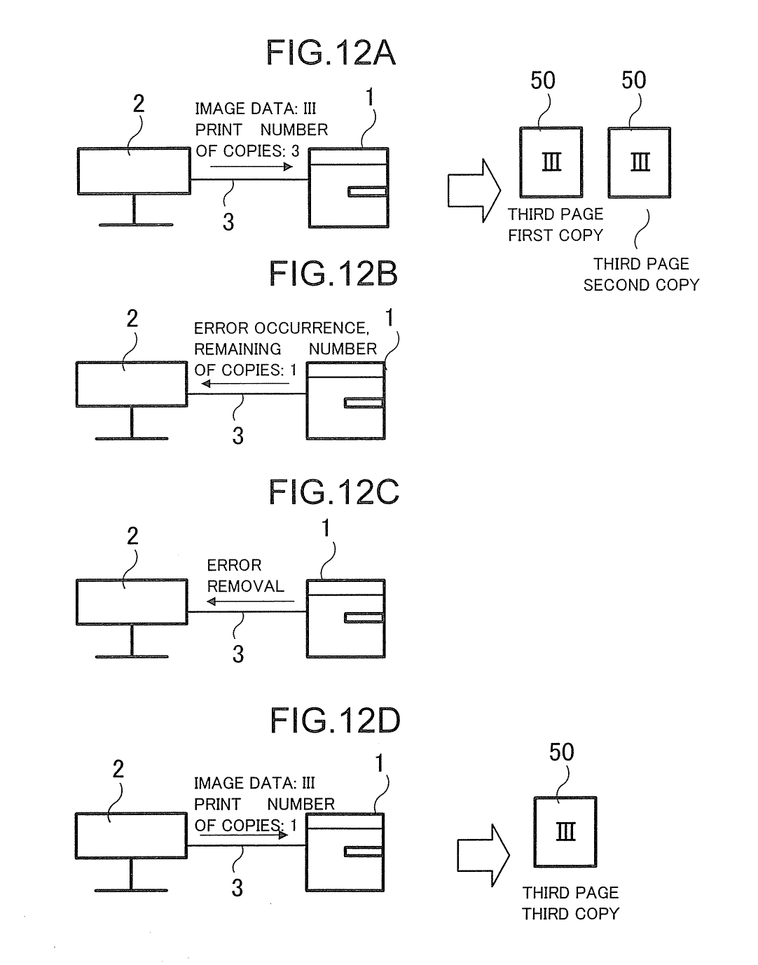

FIGS. 12A, 12B, 12C and 12D are views for explaining a procedure until printing of the third copy of the third page is completed.

As shown in FIG. 12A, after printing of the third copy of the second page is completed, the personal computer 2 sends the image data III of the third page and the print number of copies=3 to the MFP 1. The MFP 1 prints the image data III on the two sheets 50 and outputs them.

An error occurs during printing of the third copy of the image data III.

The MFP 1 calculates “the print number of copies−the number of printed copies”, that is, 3−2=1 and obtains the remaining number of copies=1.

As shown in FIG. 12B, the MFP 1 notifies the personal computer 2 of the occurrence of the error and the remaining number of copies=1. Thereafter, the user removes the clogged sheet 50, and the error is eliminated.

As shown in FIG. 12C, the MFP 1 notifies the personal computer 2 of the removal of the error. After that, the personal computer 2 starts to resume automatically.

As shown in FIG. 12D, after resumption, the personal computer 2 sends the image data III and the remaining number of copies=1 to the MFP 1.

The MFP 1 resumes printing from the image data III. The MFP 1 prints and outputs the final sheet 50.

As described above, the MFP 1 automatically resumes printing from the third copy of the third page. The sheet 50 of the third copy of the third page is printed and outputted.

Printing is performed from the personal computer 2 connected to the MFP 1 through the SUB interface. If the printing is stopped by an error during the printing, the personal computer 2 can not know the number of copies to be printed after resumption of printing.

After the error is removed, the personal computer 2 sets the previously notified number of copies to the print number of copies and resumes.

In the resumption of printing after the printing is stopped by the error, the MFP 1 can print and output the correct number of sheets.

The MFP 1 can suppress wasteful consumption of the sheet 50. The MFP 1 does not require a surplus time to complete the printing.

Even if the number of pages of a document is large and the number of copies is large, the MFP 1 can complete printing.

Incidentally, in the embodiment, the MFP 1 sends the remaining number of copies to the personal computer 2 before printing is resumed, and the personal computer 2 sends the resumption number of copies equal to the remaining number of copies to the MFP 1.

The personal computer 2 and the personal computer interface module 46 have only to use the resumption number of copies having the value substantially equal to the value of the remaining number of copies. The way of expression of the remaining number of copies and the way of expression of the resumption number of copies can be variously modified.

The MFP 1 may detect, as an error, that the life of a consumable expires.

The RAM 62 stores management information, such as the total working time and the total number of times of printing, which is used as a standard for exchange of a consumable. The ROM 61 stores a program for monitoring consumables.

The program detects that the life of the photoconductive drum 21 expires based on the management information and exchange timing information. The detection object of the program is consumption of a grid or a wire of the charging unit 22, a magnet roller of the developing unit 24, a transfer roller or a blade of the transfer unit 25, an ozone filter in the main body 10, and the like.

Although the USB plug 74 connects the personal computer 2, the USB plug 74 may connect another USB device.

The another USB device is a USB flash memory, a hard disk drive having a USB interface, a digital camera having a USB interface or the like.

The MFP 1 may be connected with a finishing apparatus. Parameters from the personal computer 2 to the MFP 1 include the presence or absence of sorting, and the position of a staple.

Although the MFP 1 uses the wired USB cable 3, the MFP 1 may include a wireless section in a transmission section to which a USB protocol is applied.

Although the MFP 1 includes the one USB plug 74, the MFP may include plural USB plugs 74.

Although the image forming process part 19 is for a monochrome image, the image forming process part may be for a color image.

In the embodiment, although the image forming apparatus is the MFP 1, the image forming apparatus may be a facsimile apparatus including the USB plug 74, a printer, or a copying machine.

The content of FIG. 5 is an example and can be variously modified.

The structure of the software module and the hardware of the MFP 1 can be variously modified. The superiority of the invention is not impaired as compared with the invention in which the structure of the software module and the hardware of the personal computer 2 are modified and carried out.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. An image forming apparatus comprising:
a transmission and reception part configured to transmit and receive a USB (universal serial bus) command to and from a computer apparatus, and receive printing data of one page and a scheduled number of copies of printing of the printing data page by page from the computer apparatus;
a sensor configured to detect occurrence of an error and removal of the error;
a printing part configured to print the printing data received by the transmission and reception part onto a sheet and stop a print process by the occurrence of the error during execution of the print process;
a storage part configured to store the number of printed sheets and the scheduled number of copies;
a calculation part configured to calculate a remaining number of copies to be printed by the printing part based on the number of printed sheets and the scheduled number of copies stored in the storage part; and
a control part configured to control the transmission and reception part to transmit the remaining number of copies calculated by the calculation part to the computer apparatus, receive a resumption number of copies having substantially a same value as the remaining number of copies from the computer apparatus after return of the print process from a printing stop by the removal of the error, and register the resumption number of copies in the storage part.

2. The apparatus of claim 1, wherein the calculation part subtracts the number of printed sheets from the scheduled number of copies and sets a subtraction result to the remaining number of copies.

3. The apparatus of claim 2, wherein the calculation part subtracts the number of printed sheets outputted during a period after resumption of the print process of the printing part and before a second stop of the print process by occurrence of an error from the remaining number of copies, and sets a subtraction result to the remaining number of copies.

4. The apparatus of claim 1, wherein the storage part stores a first correspondence relation between a page number and the scheduled number of copies, and a second correspondence relation between the page number and the resumption number of copies.

5. The apparatus of claim 4, wherein the control section selects one of the first correspondence relation and the second correspondence relation at the occurrence or the removal of the error, and causes the printing part to perform the print process based on the selected first correspondence relation or the selected second correspondence relation.

6. The apparatus of claim 1, wherein the transmission and reception part sends the USB command including a correspondence relation between the remaining number of copies and a page number to the computer apparatus, and receives the USB command including a correspondence relation between the page number and the scheduled number of copies from the computer apparatus.

7. The apparatus of claim 1, wherein after the sensor detects the occurrence of the error, the control part causes the transmission and reception part to transmit an error notification.

8. The apparatus of claim 1, wherein after the sensor detects the removal of the error, the control part causes the transmission and reception part to transmit the remaining number of copies.

9. The apparatus of claim 1, further comprising:
a RAM (random access memory) having an area for storing the printing data;
a memory control module configured to control reading and writing of the printing data; and
a printer control module configured to control the print process by the printing part,
the control part, the memory control module and the printer control module sharing the resumption number of copies.

10. The apparatus of claim 1, wherein the transmission and reception part receives the USB command including the scheduled number of copies and the resumption number of copies.

11. A printing method of an image forming apparatus, comprising:
receiving printing data of one page and a scheduled number of copies of printing of the printing data by a USB command from a computer apparatus;
starting a print process to print the printing data on a sheet and counting the number of printed sheets;
stopping the print process by occurrence of an error during execution of the print process;
calculating a remaining number of copies to be printed based on the number of printed sheets and the scheduled number of copies;
transmitting the remaining number of copies to the computer apparatus; and
receiving a resumption number of copies having substantially a same value as the remaining number of copies after return of the print process from a printing stop by removal of the error, setting the resumption number of copies and resuming the print process.

12. The method of claim 11, wherein
in the calculation of the remaining number of copies, subtracting the number of printed sheets from the scheduled number of copies.

13. The method of claim 12, wherein if the print process is again stopped by the error after the print process is resumed, in the calculation of the remaining number of copies, subtracting the number of printed sheets outputted during a period after the resumption of the print process and before the second stop of the print process from the remaining number of copies.

14. The method of claim 11, wherein
in the reception of the scheduled number of copies, storing a first correspondence relation between a page number and the scheduled number of copies, and
in the reception of the resumption number of copies, additionally storing a second correspondence relation between the page number and the resumption number of copies.

15. The method of claim 14, wherein at the occurrence of the error and the removal of the error, selecting one of the first correspondence relation and the second correspondence relation, and
the print process executing based on the selected first correspondence relation or the selected second correspondence relation.

16. The method of claim 11, wherein
in the transmission of the remaining number of copies to the computer apparatus, sending the USB command including a correspondence relation between the remaining number of copies and a page number, and
in the reception of the resumption number of copies from the computer apparatus, receiving the USB command including a correspondence relation between the page number and the scheduled number of copies.

17. The method of claim 11, wherein after the error occurs, transmitting an error notification.

18. The method of claim 11, wherein after the error is removed, transmitting the remaining number of copies.

19. The apparatus of claim 11, wherein sharing the resumption number of copies between a reading and writing control of the printing data and a control of the print process of a printing part.

20. The method of claim 11, wherein in the reception from the computer apparatus, receiving the USB command including the scheduled number of copies and the resumption number of copies.
